(19) United States
(12) Patent Application Publication
(10) Pub. No.: US 2005/0233278 A1
(43) Pub. Date: Oct. 20, 2005

(54) Pin for fixing dental model

(76) Inventor: Yunsoon Kim, Alpharetta, GA (US)

Correspondence Address: ST. ONGE STEWARD JOHNSTON & REENS, LLC, 986 BEDFORD STREET, STAMFORD, CT, 06905-5619, US

(21) Appl. No.: 10/827,774

(22) Filed: Apr. 20, 2004

(51) Int. Cl. A61C 19/00

(52) U.S. Cl. 433/74

(57) ABSTRACT

Provided is a dowel pin for fixing a dental model with a cap to be used to connect a dental model die with the dental model during the formation of a model of patient's teeth in a dental hospital or a dental laboratory. The dowel pin for fixing a dental model includes a top fixing portion having a knurling formed along an outer circumference such that it is inserted into the bottom of the dental model to a predetermined depth and firmly fixed by an adhesive, and a body formed at a lower portion of the top fixing portion by a predetermined length so that it is inserted or fitted into a pin hole of an articulator or a die on which the dental model is seated, the body having a stopper at its top portion, the stopper having a sectional area larger than that of the top fixing portion and contacting the bottom of the dental model, wherein a body cap having a plurality of separation barriers formed on an outer surface is fitted into the lower portion of the body having the stopper formed thereat, so that the body cap is firmly attached to a hardened dental model die after being embedded therein, and an end cap spaced a predetermined distance apart from the body cap is fitted to a distal end of the body in such a way as to expose a portion of the body.

### FIELD OF THE INVENTION

The present invention relates to a pin for fixing a dental model, which is used to connect a dental model die with the dental model during the formation of a model of patient's teeth in a dental hospital or a dental laboratory. More particularly, the invention relates to a dowel pin for fixing a dental model, which can prevent rotation of the dental model relative to a dental model die, which can facilitate separation of the dental model from the dental model die, and which has caps fitted to its body and distal end such that the dental model can be easily removed from a hardened dental cement or plaster forming the dental model die.

### DESCRIPTION OF THE RELATED ART

In general, prosthetic works are performed in dental hospitals for restoration of decayed or damaged teeth. The prosthetic work begins with a dental hospital taking an impression of some or all of a patient's teeth, which provides a negative model. The dental hospital sends the impression to a dental laboratory, which in turn makes a dental model required for prosthetic treatment by pouring the impression with dental cement, plaster, or casting stone made of thermoplastic material.

To make a replica conforming to the actual dentition of the patient, the formed dental model is affixed to a dental model die (Hereinafter, the terms “die” and “dental model die” used herein are intended to have the same meaning.), and the dental model is removed from the dental model die by separate cutting for preparation of a dental prosthesis suitable for the patent's teeth. Next, the dental model is repositioned in the dental model die in order to examine interference with adjacent (left and right) teeth, or masticating ability with respect to opposing (up and down) teeth, thereby completing the prosthetic work suitable for the patient's dentition. A dental model from which a dental prosthesis is prepared is formed by making a replica conforming to the actual patient's teeth. That is, to perform a series of stages of the prosthetic work, the bottom of a segment of the dental model encompassing a tooth requiring treatment or the adjacent teeth is drilled to form a groove therein, and then a top of a dowel pin is fixed into the bottom of a segment of the dental model with an adhesive. A body portion and a bottom of the dowel pin are then embedded in the die before hardening of the dental cement or plaster poured in the mold for forming the die, thus integrating the dental model into the die after hardening.

As described above, a dental model representing the patient's dental configuration fixed into the dental model die is cut into segments in such a manner that a segment of the dental model corresponding to a tooth requiring prosthetic treatment or the adjacent teeth can easily be separated from the dental model die. Thereafter, the segment is repositioned to the original position by examining the height difference between or interference with adjacent teeth, and masticating ability with respect to opposing teeth, for precise alignment.

In other words, the dowel pin not only facilitates separation of a segment of the dental model corresponding to a tooth requiring prosthetic treatment or the adjacent teeth from the dental model die but also helps to precisely reposition the dental model with respect to the dental model die after separation. The dowel pin plays an important role in the prosthetic treatment using the dental model by facilitating frequent separation and combination between the dental model and the dental model die. Thus, quick separation and combination by insertion of the dowel pin increases efficiency and productivity of the prosthetic work while decreasing labor costs involved in manual work.

The dowel pin is shaped or constructed to provide patients with structurally strong and precise tooth restoration and to reduce costs by facilitating workflows in dental prosthetic laboratories. The improved workflows in turn result in increased productivity and superb, prompt services for dental patients.

Due to importance in role of the dowel pin for use in a dental model, various techniques for determining its shape or structure have conventionally been developed and proposed in numerous patents.

For example, to prevent rotation of a dental model relative to a die, the bottom of the dental model may be drilled for receiving a plurality of pins that fix it to the die with an adhesive. This approach allows robust fixation of the dental model but consumes a lot of time it takes to insert the dowel pin into the dental model so work efficiency decreases. Another drawback is to increase the manufacturing costs due to the use of the plurality of pins. Still another drawback is that it is difficult to use the dowel pin for a dental model for a small dental model of an anterior tooth.

To solve the problems associated with use of the plurality of dowel pins, U.S. Pat. No. 4,139,943 discloses a dowel pin designed to prohibit any oscillation or rotation of a dental model relative to a die due to the presence of one body portion and two leg members while offering a dental model, accurate in size and shape, of actual dentition of a patient. The complicated structure of the dowel pin in the above-cited reference increases the manufacturing costs including a die fabrication cost while making separation of the pin from the die difficult.

U.S. Pat. No. 4,521,188 discloses another dowel pin including a body portion having a plurality of facets that provide numerous planes, edges and angles to constrain movement of the dowel pin with respect to an associated die. In addition, U.S. Pat. Nos. 4,054,995 and 4,060,899 propose dowel pins with a sleeve and with a socket disposed along the outer circumferences, respectively.

However, the conventional dowel pins in the above-cited references have a drawback that it is difficult to remove the dental model from the die because the bottom surface of the dental model is firmly fixed to the top surface of the die, and a pin body portion is firmly attached to the die by insertion. Thus, if an operator applies too much force for separation, the neck portion of the dowel pin tends to be broken or a top of the dowel pin inserted into the bottom of the dental model may be easily separated away from the dental model. Another drawback is that it is inconvenient to use the dowel pin for a small dental model due to spatial limitations.

### SUMMARY OF THE INVENTION

The present invention provides a dowel pin for fixing a dental model with a cap constructed to improve workflows and productivity in inserting the dowel pin into a dental model in a dental prosthetic laboratory.

The present invention also provides a dowel pin for fixing a dental model with a cap integrated to allow a sufficient space for installation in a small dental model as well as a large one, thus improving workflows, while enabling robust fixation of the dental model into a die. The dowel pin is constructed to facilitate smooth separation of the dental model from the die without applying excessive force, thus preventing the dowel pin from being broken away. Even if the dowel pin is broken, the symmetrical shape makes repairing easy and quick.

In particular, according to the present invention, the dental model can be easily removed from the robustly constructed die by pushing up the bottom of the dowel pin with a predetermined instrument after removing an end cap from the bottom of the die, instead of forcibly plucking the top of the dental model, thus allowing quick prosthetic treatment by improving workflows and reducing a working time while providing superb, prompt services to patients.

Furthermore, since the dowel pin has a simplified body configuration, its molding pattern is easy to manufacture with the low manufacturing costs, thereby reducing the cost burden on patients.

According to an aspect of the present invention, there is provided a dowel pin for fixing a dental model including a top fixing portion having a knurling formed along an outer circumference such that it is inserted into the bottom of the dental model to a predetermined depth and firmly fixed by an adhesive, and a body formed at a lower portion of the top fixing portion by a predetermined length so that it is inserted or fitted into a pin hole of an articulator or a die on which the dental model is seated, the body having a stopper at its top portion, the stopper having a sectional area larger than that of the top fixing portion and contacting the bottom of the dental model, wherein a body cap having a plurality of separation barriers formed on an outer surface is fitted into the lower portion of the stopper formed at the body, so that the body cap is firmly attached to a hardened dental model die after being embedded therein, and an end cap spaced a predetermined distance apart from the body cap is fitted to a distal end of the body in such a way as to expose a portion of the body.

Preferably, a horizontally-cut portion, which is formed on two opposite sides of the body, is perpendicularly cut at a position spaced a predetermined distance downward apart from the upper surface of the stopper to a predetermined depth inwardly from the outer circumferential surface of the body, such that the perpendicularly cut portion has a stepped configuration having a predetermined step height relative to the outer circumferential surface of the body. A vertically-cut portion extends longitudinally from an inner edge of the horizontally-cut portion in a direction perpendicular to the horizontally-cut portion. A rounded tapering portion is formed on either side of the body where the vertically-cut portion is formed. Also, a recessed pressure groove is formed in the bottom of the body.

Also, the fitting hole of the end cap may have rounded edges at its entrance to facilitate insertion of the distal end of the body into the fitting hole, a separation through hole penetrating the bottom of the end cap is formed on the inner bottom of the fitting hole, and a rounded tapering portion is formed along its outer circumference, the rounded tapering portion having a cross-section gradually decreasing from the bottom in which the separation through hole is formed toward the upper portion where the fitting hole is formed.

Certain preferred embodiments of the dowel pin for fixing a dental model with a cap according to the present invention are shown in the accompanying drawings and the following description, which are given by way of illustration only, and thus are not limitative of the present invention.

### BRIEF DESCRIPTION OF DRAWINGS

FIG. 1 is a perspective view of a dowel pin for fixing a dental model with a cap according to the present invention;

FIG. 2 is an exploded view of FIG. 1;

FIGS. 3 and 4 are front and side views of a dowel pin according to the present invention, respectively;

FIGS. 5 and 6 are perspective view and a cross-sectional view of the end cap shown in FIG. 1, respectively;

FIG. 7 is a cross-sectional view of FIG. 1;

FIG. 8 is cross-sectional view showing a partial dental model attached to a die into which a dowel pin is inserted; and

FIGS. 9 and 10 illustrate operation of removing an end cap in order to separate a partial dental model from the bottom of a die.

### DETAILED DESCRIPTION OF EMBODIMENTS

A dowel pin for fixing a dental model with a cap according to a preferred embodiment of the present invention will now be described with reference to the accompanying drawings.

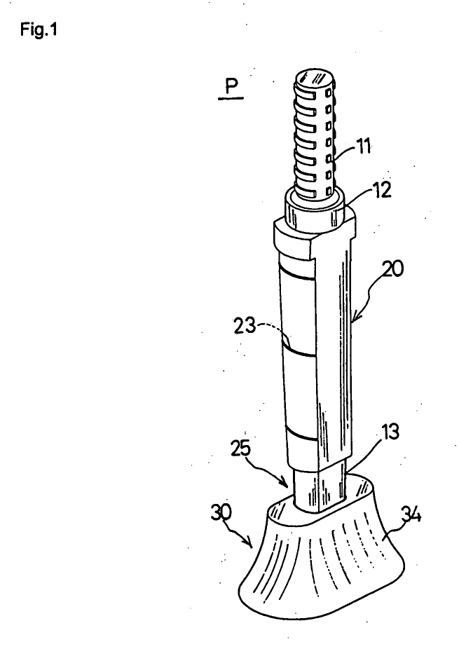

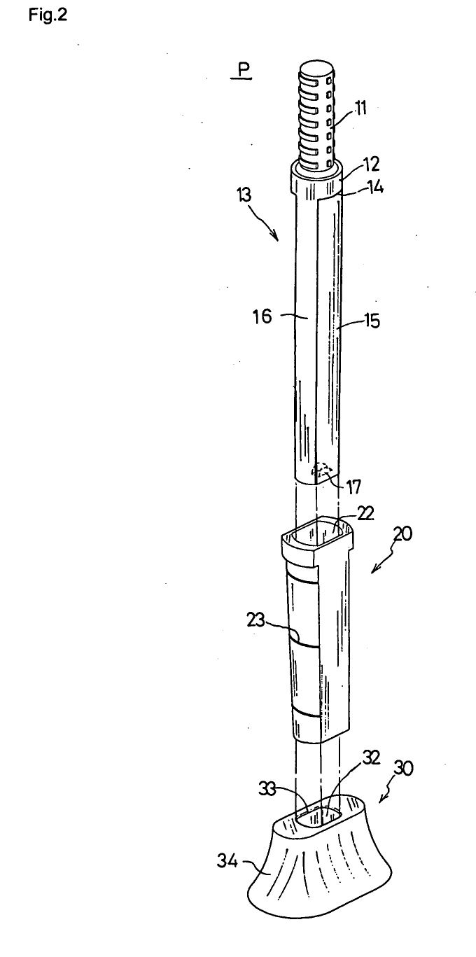

FIG. 1 is a perspective view illustrating an external appearance of the dowel pin for fixing a dental model with a cap according to the present invention, and FIG. 2 illustrates a state in which the pin and the cap (Hereinafter, the term “cap” used herein is intended to mean both a body cap 20 and an end cap 30.) are separated from each other.

As shown in FIGS. 1 and 2, a dowel pin P for fixing a dental model with a cap includes a top fixing portion 11 and a body 13. The top fixing portion 11 has a knurling formed along an outer circumference such that it is inserted into the bottom of the dental model to a predetermined depth and firmly fixed by an adhesive. The body 13 is formed at lower portion of the top fixing portion 11 by a predetermined length so that it is inserted or fitted into a pin hole of an articulator or a die on which the dental model is seated. Also, the body 13 has a stopper 12 at its top portion. The stopper 12 has a sectional area larger than that of the top fixing portion 11 and contacts the bottom of the dental model. The lower portion of the body 13 is shaped so as to effectively prevent rotation of the dental model relative to a dental model die.

In particular, a body cap 20 made of a soft plastic material is fitted around the outer circumference of the body 13, and an end cap 30 is spaced apart a predetermined distance from the body cap 20 and fitted to a distal end of the body 13. That is, the body cap 20 has an inner insertion portion 22 and a plurality of outer separation barriers 23. The inner insertion portion 22 has the same shape as the outer circumference of the body 13, and the plurality of outer separation barriers 23 have various shapes and heights such that the body cap 20 is firmly attached to a plaster forming the dental model die after being embedded therein. The end cap 30 is fitted to a distal end of the body 13 and spaced apart from the body cap 20 a predetermined distance in such a manner that a portion of the body 13 excluding the portion of the body 13 surrounded by the body cap 20 may be exposed directly to the plaster of the dental model die.

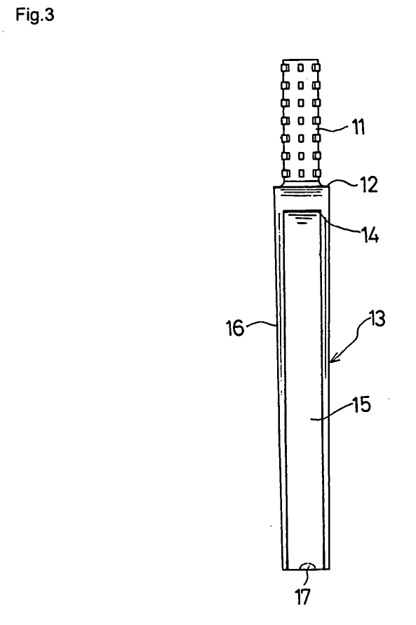

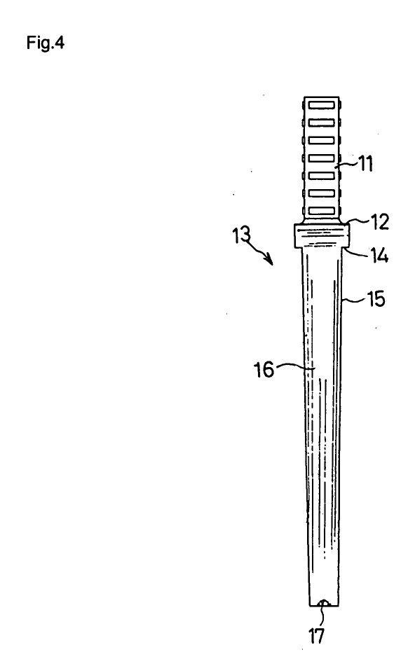

FIGS. 3 and 4 are front and side views of the dowel pin from which the body cap 20 and the end cap 30 have been removed, for illustrating the construction of the dowel pin according to the present invention in a greater detail, in particular, for better understanding of features of the body 13.

The body 13 with the caps 20 and 30 are embedded in the die to prevent rotation of the dental model relative to the die while facilitating separation and combination between the dental model and die.

The body 13 has a horizontally-cut portion 14 formed on either side thereof, a vertically-cut portion 15, and a rounded tapering portion 16. The horizontally-cut portion 14 is perpendicularly cut at a position spaced a predetermined distance apart downward from the upper surface of the stopper 12 to a predetermined depth inwardly from the outer circumferential surface of the body 13 such that the perpendicularly cut portion has a stepped configuration having a predetermined step height relative to the outer circumferential surface of the body 13. The vertically-cut portion 15 extends longitudinally from an inner edge of the horizontally-cut portion 14 in a direction perpendicular to the horizontally-cut portion 14. The rounded tapering portion 16 is formed on either side of the body 13 where the vertically-cut portion 14 is formed, in a tapered form so as to have a gradually decreasing sectional width as it moves downward from the outer circumferential surface of the stopper 12, or has a sectional width that minutely increases to reach a position spaced a predetermined length apart from the outer circumferential surface of the stopper 12 and then gradually decreases downward to the distal end of the body 13 until the sectional width thereof becomes less than that of the stopper 12.

The body 13 further includes a pressure groove 17 in the bottom, which is recessed to a predetermined depth such that the dowel pin can be easily pushed out of the bottom of the die from which the end cap 30 has been removed with a sharp-ended instrument such as a dental knife when the dental model is separated from the die.

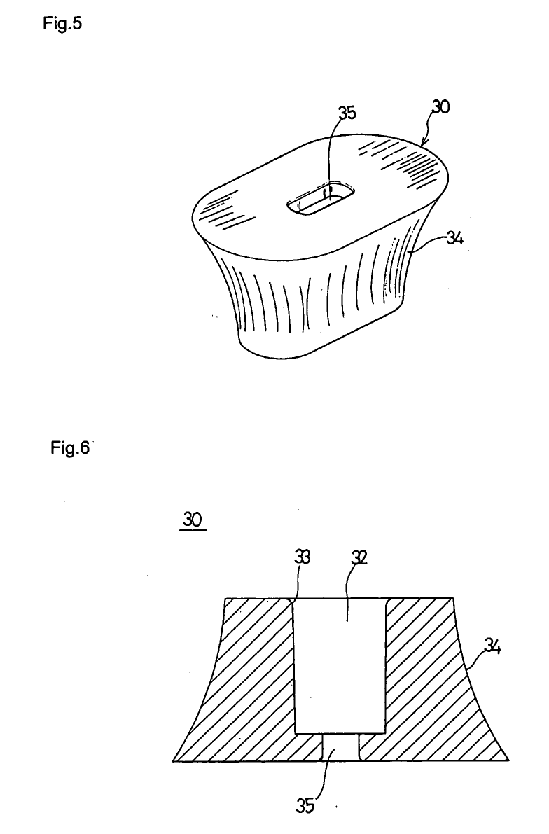

FIGS. 5 and 6 are bottom perspective view and cross-sectional view of the end cap 30 fitted to the distal end of the body 13 of the dowel pin.

As shown in FIGS. 5 and 6, the end cap 30 fitted with the body portion 13 is embedded in the die together with the body cap 20 when a plaster material in the die is hardened. The end cap 30 has a separation through hole 35 connecting to the inner bottom of a fitting hole 32, which facilitates removal of the end cap 30 from the bottom of hardened die in which the dowel pin for fixing the dental model is embedded using a predetermined instrument when a segment of the dental model corresponding to a tooth requiring prosthetic treatment is cut from the overall dental model and then the segment is initially separated from the dental model die.

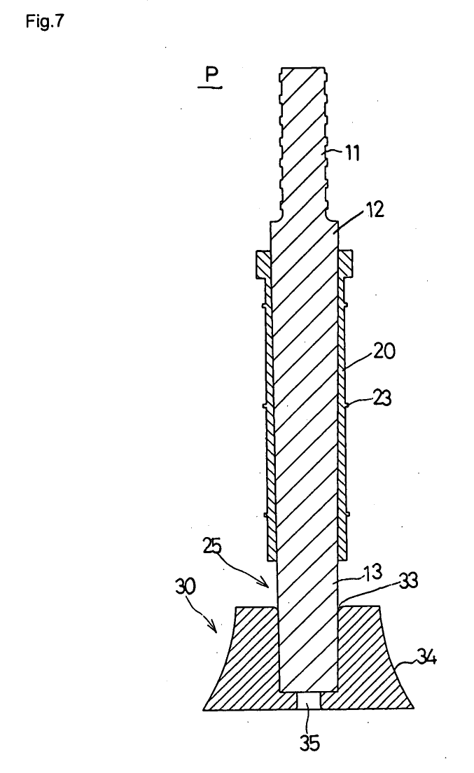

Furthermore, edges 33 at an entrance of the fitting hole 32 are rounded to have an appropriate slope to facilitate insertion of the distal end of the body 13 into the fitting hole 32. The end cap 30 further includes a rounded tapering portion 34 formed along its outer circumference, the rounded tapering portion 34 having a cross-section gradually decreasing from the bottom in which the separation through hole 35 is formed toward the entrance of the fitting hole 32 such that the end cap 30 can be readily removed from the bottom of the die. The cross-section of the dowel pin P for fixing a dental model fitted with the body cap 20 and the end cap 30 according to the present invention is shown in FIG. 7.

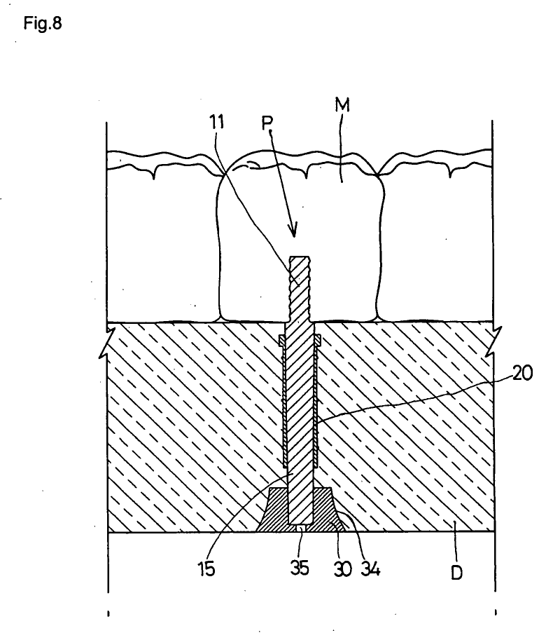

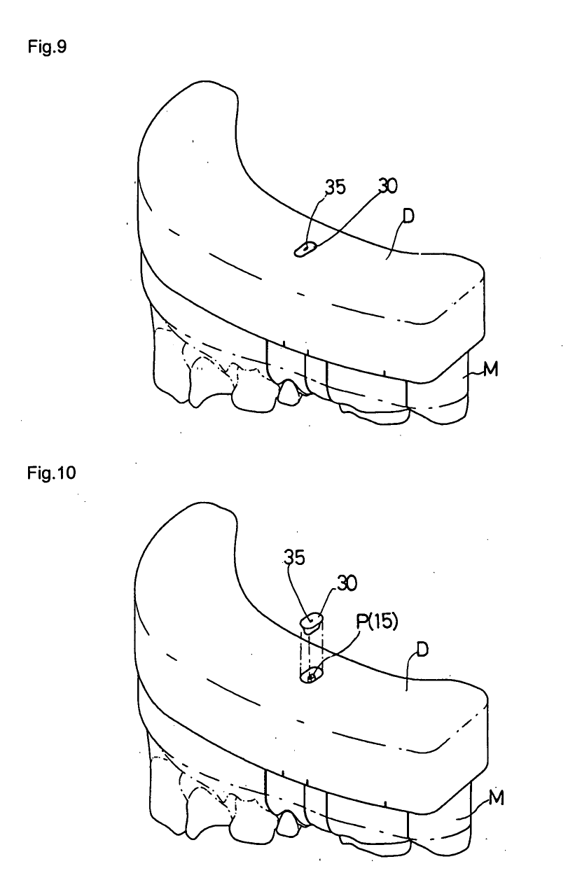

The operation and effect of the present invention will now be described with references to FIGS. 8-10 showing the state in which the dowel pin P according to a preferred embodiment has been used.

Like in conventional dowel pins, according to the present invention, a dental model M is formed in a dental laboratory with an impression or bite taken of a patient's tooth by a dental hospital, the bottom of a segment of the dental model. M requiring prosthetic treatment is drilled to form a groove. Then, the top fixing portion 11 of the dowel pin P with the caps 20 and 30 is fitted into the groove with an adhesive applied along the outer circumference thereof, thereby inserting the dowel pin P into the dental model M. In such a manner, the dowel pin P and the dental model M are integrally combined together.

The body 13 of the dowel pin P fitted into the dental model M is also embedded in the top surface of a dental cement or plaster poured in a rubber mold for forming a dental model die D before hardening and then inserted into the dental model die D by forcibly exerting pressure, thereby integrating the dental model M into the dental model die D. Furthermore, when a segment of the dental model M attached to the dental model die D requiring prosthetic treatment is cut for separation, the body 13 of the dowel pin P allows precise positioning of the segment with respect to the dental model die D so that it can be returned to the original position.

One advantage of the dowel pin P with the caps 20 and 30 for fixing the dental model M is to facilitate separation and combination between the dental model M and the hardened dental model die D, thereby improving workflows and productivity. Another advantage is that the dowel pin P is easy to repair in the event of being broken due to excessive force applied upon separation and combination. Still another advantage is to prevent movement of the dental model M by being inserted into the precise location of the dental model M, thereby allowing precise tooth restoration.

More specifically, referring to FIG. 8 showing the state in which the dental model M is attached to the top surface of the dental model die D, the body cap 20 made of soft plastic material such as polypropylene (PP) is fitted around the outer circumference of the body 13 where the sectional width of the vertically-cut portions 15 is less than that of the rounded tapering portion 16. Thus, the outer circumference of the body 13 is kept fixed within the body cap 20 at a predetermined pressure by partially absorbing contraction in volume of a plaster during hardening of the dental model die D, thereby prohibiting movement of the dowel pin P in the body cap 20.

In particular, since the body 13 has an exposed portion 25 between the body cap 20 and the end cap 30, which is artificially exposed to the plaster in the dental model die D, the plaster directly constrains the exposed portion 25 of the body 13, thereby effectively preventing possible movement of the dowel pin P. In addition, the dowel pin P is effectively separable from the dental model M compared to a conventional dowel pin without a cap, which is completely constrained to a hardened plaster of a die so that it makes initial separation of a dental model difficult. Further, since the body cap 20 completely wraps the body 13, the body 13 of the dowel pin P can be prevented from moving in the body cap 20, unlike in the conventional body cap which is made of a metal.

Furthermore, although the body 13 has a simplified configuration, it has the vertically-cut portion 15 and the rounded tapering portion 16 with different sectional widths, both being symmetrical to each other, which makes it possible to effectively prohibit left-right movement of the dowel pin and thus allow precise tooth restoration. Also, since positioning the vertically-cut portion 15 with a small sectional width on either side of the body 13 decreases the space taken up by the dowel pin P, it is also possible to use the dowel pin P for fixing a small dental model of an anterior tooth instead of another dowel pin.

Meanwhile, conventionally, a dental model is removed from a dental model die by pushing up the cut dental model with a hand. However, since the bottom surface of the dental model is strongly attached to the top surface of the dental model die and a dowel pin is firmly fixed to the dental mold die by hardened plaster of the dental mold die, it is extremely difficult to initially separate the dental model from the dowel pin and the die. In the event that an excessive force is applied on the dental model for separation, it significantly impedes the prosthetic work, for example, by breaking a neck portion of the dowel pin.

In contrast, when the dowel pin P with the caps 20 and 30 is employed, the dental model M can be readily removed from the dental model die D by separating the dowel pin P from the dental model die D, which can be achieved by pushing the dowel pin P using a sharp-ended instrument such as a dental knife inserted into the separation through hole 35 of the end cap 30 instead of forcibly plucking the dental model M. In particular, it is easy to separate the dowel pin P from the hardened plaster due to the presence of the rounded tapering portion 16 having a sectional width progressively decreasing in a direction opposite to that in which the body 13 of the dowel pin P is separated from the dental model die D. Also, the dowel pin P is easily separated from the hardened plaster due to a slippery surface of the end cap 20.

Furthermore, since only the exposed portion 25 of the outer circumference of the dowel pin P is fixed by the hardened plaster of the dental model die D while the remaining portion is indirectly constrained by the body cap 20 and the end cap 30, it allows robust fixation of the dental model M to the dental model die D as well as smooth and easy separation from the dental model die D.

Since the dowel pin P is tapered in a direction opposite to that in which the body 13 of the dowel pin P is drawn when the dental mold M is separated from the dental model die D, there is little need to exert a strong force excluding a predetermined force exerted at the beginning of the separation. Furthermore, the distal end of the dowel pin P having the smallest cross-sectional area is fitted into the body cap 20 having the largest cross-sectional area upon combination. Thus, the dowel pin P is constructed to facilitate quick separation and combination between the dental model M and the dental model die D, thus improving efficiency of the prosthetic work.

Since the dowel pin P for fixing a dental model contains the vertically-cut portion 15 and the rounded tapering portion 16 with different sectional area on either side of the body 13, it is possible to fix both small and large dental models with a single pin by changing the position of the body 13 according to the direction of dowel pin P installed. This eliminates the need to install a plurality of dowel pins, thereby saving the cost and time during installation and thus increasing productivity. In the event where a neck or body 13 of the dowel pin P is broken with excessive force during separation of the dental model, the symmetrical shape of the body 13 makes it easy to reattach the broken portion.

When the dowel pin P is fitted into a pin fixing hole of an articulator and then a base material or a plaster for a dental model is coated over the top of the dowel pin P for enclosure, the stopper 12 having a constant cross-sectional area below the top fixing portion 11 prevents inflow of the plaster into the pin fixing hole, thus allowing easy separation of a dental model from the articulator after hardening of the plaster. Furthermore, when the top fixing portion 11 is fitted into a groove formed in the dental model, the stopper 12 prevents the adhesive applied along the outer circumference of the top fixing portion 11 from flowing down the body 13.

1. A dowel pin for fixing a dental model comprising:
a top fixing portion having a knurling formed along an outer circumference such that it is inserted into the bottom of the dental model to a predetermined depth and firmly fixed by an adhesive; and
a body formed at a lower portion of the top fixing portion by a predetermined length so that it is inserted or fitted into a pin hole of an articulator or a die on which the dental model is seated, the body having a stopper at its top portion, the stopper having a sectional area larger than that of the top fixing portion and contacting the bottom of the dental model,
wherein a body cap having a plurality of separation barriers formed on an outer surface is fitted into the lower portion of the stopper formed at the body so that the body cap is firmly attached to a hardened dental model die after being embedded therein, and an end cap spaced a predetermined distance apart from the body cap is fitted to a distal end of the body in such a way as to expose a portion of the body.

2. The dowel pin of claim 1, wherein a horizontally-cut portion, which is formed on two opposite sides of the body, is perpendicularly cut at a position spaced a predetermined distance downward apart from the upper surface of the stopper to a predetermined depth inwardly from the outer circumferential surface of the body such that the perpendicularly cut portion has a stepped configuration having a predetermined step height relative to the outer circumferential surface of the body; a vertically-cut portion extends longitudinally from an inner edge of the horizontally-cut portion in a direction perpendicular to the horizontally-cut portion; a rounded tapering portion is formed on either side of the body where the vertically-cut portion is formed; and a recessed pressure groove is formed in the bottom of the body.

3. The dowel pin of claim 2, wherein the tapering portion is formed in a tapered form so as to have a sectional width that minutely, gradually increases to reach a position spaced a predetermined length apart downward from the outer circumferential surface of the stopper and then gradually decreases downward to the distal end of the body until the sectional width thereof becomes less than that of the stopper.

4. The dowel pin of claim 1, wherein the fitting hole of the end cap has rounded edges at its entrance to facilitate insertion of the distal end of the body into the fitting hole, a separation through hole penetrating the bottom of the end cap is formed on the inner bottom of the fitting hole, and a rounded tapering portion is formed along its outer circumference, the rounded tapering portion having a cross-section gradually decreasing from the bottom in which the separation through hole is formed toward the upper portion where the fitting hole is formed.

5. The dowel pin of claim 1, wherein the body cap and the end cap are made of soft plastic materials.
